(19) United States
(12) Patent Application Publication
(10) Pub. No.: US 2010/0193253 A1
(43) Pub. Date: Aug. 5, 2010

(54) EARTH-BORING TOOLS AND BODIES OF SUCH TOOLS INCLUDING NOZZLE RECESSES, AND METHODS OF FORMING SAME

(76) Inventors: Alan J. Massey, Houston, TX (US); Kenneth E. Gilmore, Cleveland, TX (US)

Correspondence Address: TRASKBRITT, P.C., P.O. BOX 2550, SALT LAKE CITY, UT, 84110, US

(21) Appl. No.: 12/363,424

(22) Filed: Jan. 30, 2009

(51) Int. Cl. E21B 10/60; B21K 5/04; B23P 6/00

(52) U.S. Cl. 175/393; 76/108.1; 29/402.01

(57) ABSTRACT

Earth-boring tools such as, for example, earth-boring rotary drill bits include erosion-resistant structures disposed proximate areas of intersection between faces of the tools and fluid nozzle recesses or fluid passageways extending through the tools to the face. In some embodiments, such an erosion-resistant structure may comprise a mass of hardfacing material. In additional embodiments, such an erosion-resistant structure comprises an erosion-resistant insert. Methods of forming such earth-boring tools include providing erosion-resistant structures proximate intersections between the faces of the tools and fluid nozzle recesses or fluid passageways extending through the tools. Methods of repairing earth-boring tools include providing an annular-shaped, erosion-resistant structure over an eroded surface of a body of a previously used earth-boring tool proximate an intersection between an outer face of the body and an inner surface of the body.

### CROSS-REFERENCE TO RELATED APPLICATIONS

Not Applicable.

### TECHNICAL FIELD

Embodiments of the present invention relate to methods, systems, tools, and tool bodies for forming wellbores in subterranean earth formations and, more specifically, to methods, systems, tools, and tool bodies for preventing erosion of tool bodies including nozzle recesses.

### BACKGROUND

Wellbores are formed in subterranean formations for various purposes including, for example, extraction of oil and gas from the subterranean formation and extraction of geothermal heat from the subterranean formation. A wellbore may be formed in a subterranean formation using a drill bit such as, for example, an earth-boring rotary drill bit. Different types of earth-boring rotary drill bits are known in the art including, for example, fixed-cutter bits (which are often referred to in the art as “drag” bits), rolling-cutter bits (which are often referred to in the art as “rock” bits), diamond-impregnated bits, and hybrid bits (which may include, for example, both fixed cutters and rolling cutters). The drill bit is rotated and advanced into the subterranean formation. As the drill bit rotates, the cutters or abrasive structures thereof cut, crush, shear, and/or abrade away the formation material to form the wellbore.

Bodies of earth-boring tools, such as rotary drill bits, often include fluid passageways that extend through the bodies to face of the tools. Drilling fluid may be pumped through the tool bodies to the face of the tools through these fluid passageways. Nozzle recesses are often formed in the bodies of such tools at the end of the fluid passageways proximate the face of the bodies. Fluid nozzles may be inserted into and retained within the nozzle recesses. The nozzles retained within the nozzle recesses may be configured with suitably sized and shaped orifices to impart desirable characteristics (e.g., fluid velocity, spray direction, and spray pattern) to the drilling fluid flowing through the fluid passageways to the face of the tool. The drilling fluid is employed to cool and clean cutting structures on the earth-boring tool and to flush and clear formation material as the wellbore is drilled, such formation material being carried up the wellbore annulus between the drill string to which the earth-boring tool is secured and the wellbore wall.

FIG. 1 is an enlarged partial cross-sectional view of a portion of an earth-boring tool 10 for use in subterranean drilling illustrating a nozzle assembly 12 of the tool 10. While many earth-boring tools employ single-piece nozzles, the nozzle assembly 12 shown in FIG. 1 is a two piece replaceable nozzle assembly, the first piece being a tubular tungsten carbide inlet tube 14 that fits into a fluid passageway 26 in the body 30 of the tool 10. A nozzle recess 16 is formed in the body 30 where the fluid passageway 26 meets the face 31 of the body 30. The inlet tube 14 of the nozzle assembly 12 is seated upon an annular shoulder 18 defined by an inner surface of the body 30 where the nozzle recess 16 meets the fluid passageway 26. The second piece of the nozzle assembly 12 is a tungsten carbide nozzle 20 having a restricted bore 22. The nozzle 20 is secured within the nozzle recess 16 by threads which engage mating threads 24 on the surfaces of the body 30 within the nozzle recess 16. The inlet tube 14 is retained in the fluid passageway 26 by an abutment between the annular shoulder 18 and the end of the nozzle 20. An O-ring 28 is disposed in an annular groove formed in the wall of the nozzle recess 16 to provide a fluid seal between the adjacent surfaces of the body 30 and the nozzle 20, thus forcing fluid flowing through the fluid passageway 26 to flow through the inside of the inlet tube 14 and the nozzle 20.

During use, the flow of the high velocity, high pressure, solids-laden drilling fluid through the nozzle assembly 12 and splash-back of the drilling fluid from the formation face upon which drilling fluid impinges may erode the generally circular edges 34 defined by the intersections between the face 31 of the body 30 of the tool 10 and the surfaces of the tool body within the nozzle recesses 16 (or fluid passageways 26). If these edges 34 erode to a significant extent, the drilling hydraulics of the tool 10 may be detrimentally affected, and the tool 10 may be incapable of performing efficiently.

### BRIEF SUMMARY OF THE INVENTION

In some embodiments, the present invention includes earth-boring tools that include a body having an outer face and an inner surface defining at least one of a fluid passageway and a nozzle recess in the body. An annular-shaped structure is disposed proximate an area of intersection between the outer face of the body and the inner surface of the body. The annular-shaped structure comprises a material that exhibits an erosion resistance greater than an erosion resistance exhibited by a material of the body.

In additional embodiments, the present invention includes methods of forming earth-boring tools in which an annular-shaped structure is provided proximate an area of intersection between an outer face of a body of the earth-boring tool and an inner surface of the body of the earth-boring tool. A material of the annular-shaped structure is selected to comprise a material exhibiting an erosion resistance greater than an erosion resistance exhibited by a material of the body.

In additional embodiments, the present invention includes earth-boring rotary drill bits having a bit body comprising an outer face, an inner surface defining a nozzle recess in the bit body. A surface extends between the outer face of the bit body and the inner surface of the bit body, and the surface defines a recess in the bit body proximate an area of intersection between the outer face and the inner surface. Hardfacing material is disposed within the recess. The hardfacing material exhibits an erosion resistance greater than an erosion resistance exhibited by a material of the bit body.

In yet further embodiments, the present invention includes methods of repairing earth-boring tools in which an annular-shaped structure is provided over an eroded surface of a body of a previously used earth-boring tool between an outer face of the body and an inner surface of the body, and a material of the annular-shaped structure is selected to comprise a material exhibiting an erosion resistance greater than an erosion resistance exhibited by a material of the body.

### BRIEF DESCRIPTION OF THE SEVERAL VIEWS OF THE DRAWINGS

While the specification concludes with claims particularly pointing out and distinctly claiming that which is regarded as the present invention, various features and advantages of this invention may be more readily ascertained from the following description of the invention when read in conjunction with the accompanying drawings, in which:

FIG. 1 is an enlarged cross-sectional partial view of a portion of a body of a prior art earth-boring tool;

FIG. 2 is a perspective view of an embodiment of an earth-boring tool of the present invention;

FIG. 3 is an enlarged cross-sectional partial view of a portion of a body of the earth-boring tool shown in FIG. 2 taken along section line 3-3 shown therein and illustrates a nozzle recess in the body of the earth-boring tool;

FIG. 4 is an enlarged cross-sectional partial view like that of FIG. 3 illustrating another embodiment of an earth-boring tool of the present invention;

FIG. 5 is an enlarged cross-sectional partial view like that of FIG. 4 illustrating an example embodiment of a method that may be used to form the body shown in FIG. 4;

FIG. 6 is an enlarged cross-sectional partial view of a portion of the body of the earth-boring tool shown in FIG. 1 after using the tool in forming a wellbore and illustrates erosion that may occur to the body of the tool; and

FIG. 7 illustrates an embodiment of an earth-boring tool of the present invention that may be formed by repairing the body shown in FIG. 6, and is used to describe embodiments of methods of the present invention that may be used to repair previously used earth-boring tools.

### DETAILED DESCRIPTION OF THE INVENTION

The illustrations presented herein are not actual views of any particular drilling system, earth-boring tool, or body of an earth-boring tool, but are merely idealized representations that are employed to describe the present invention.

Embodiments of the present invention may be used to hinder or prevent erosion of the surfaces of a body of an earth-boring tool located in the area of intersection between a face or exterior surface of the body and an inner surface of the body within a fluid passageway such as, without limitation, a nozzle recess extending into the body from the face or other exterior surface of the body. The term “erosion” refers to a two body wear mechanism that occurs when solid particulate material, a fluid, or a fluid carrying solid particulate material impinges on a solid surface, such as may occur when drilling fluid is pumped through and around a drill bit or other drilling tool during a drilling operation.

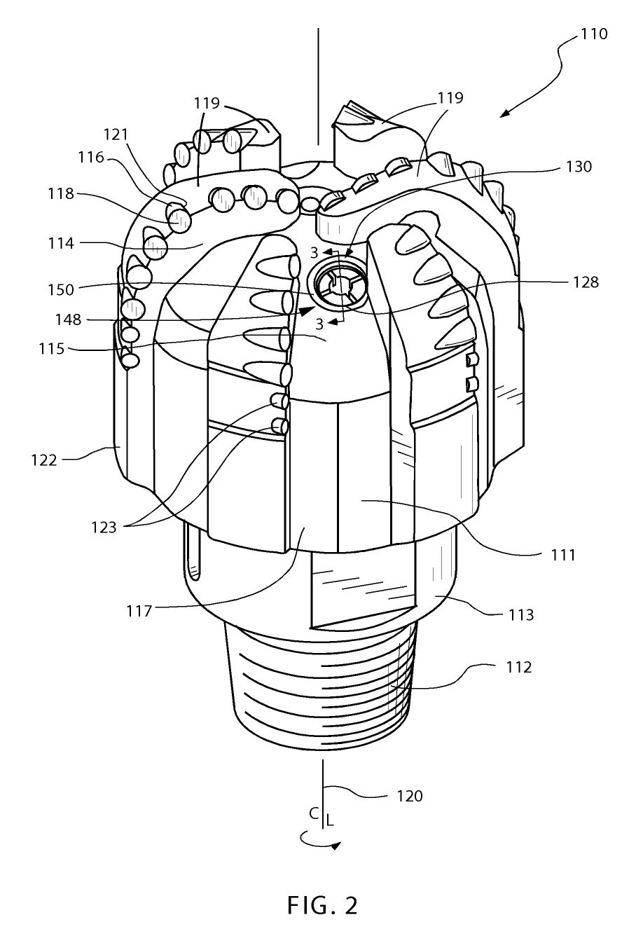

FIG. 2 is a perspective view of an example embodiment of an earth-boring tool of the present invention. The earth-boring tool of FIG. 2 is a fixed-cutter earth-boring rotary drill bit 110. Such fixed-cutter drill bits are also referred to in the art as “drag” bits. The drill bit 110 includes a plurality of nozzle assemblies 130, as discussed in further detail hereinbelow.

The drill bit 110 includes a bit crown or body 111 coupled to a shank 113. The bit body 111 may comprise steel or another metal alloy. In other embodiments, however, the bit body 111 may comprise a particle-matrix composite material comprising hard particles (e.g., particles of tungsten carbide) dispersed throughout a metal matrix material (e.g., an iron-based, nickel-based, cobalt-based, or copper-based metal alloy). The shank 113 also may comprise a steel or another metal alloy.

The bit body 111 may be coupled-to the shank 113 by, for example, welding the shank 113 to the bit body 111 circumferentially around the drill bit 110 along an interface between the shank 113 and the bit body 111. The shank 113 of the drill bit 110 includes a threaded pin 112, which may be adapted for connection to a component of a drill string. The threaded pin 112 may conform to industry standards such as those promulgated by the American Petroleum Institute (API).

The face 114 of the bit body 111 has mounted thereon a plurality of cutting elements 116, each of which may comprise a polycrystalline diamond compact (PDC) cutting element. Such PDC cutting elements may include a table 118 of polycrystalline diamond material formed on or attached to a cemented tungsten carbide substrate. The cutting elements 116 may be mounted on wings or blades 119 of the bit body 111, between which are defined fluid passages 115 and junk slots 117. The cutting elements 116 may be secured in respective cutter pockets 121 formed in the blades by, for example, brazing the cutting elements 116 in the pockets 121 using a metal brazing alloy material. The cutting elements 116 are configured, sized, and positioned to cut a subterranean formation being drilled when the drill bit 110 is rotated under weight on bit (WOB) in a wellbore. The bit body 111 may include gage trimmers 123. The gage trimmers 123 may comprise PDC cutting elements having diamond tables 118 configured with a flat edge aligned parallel to the rotational axis 120 of the bit (not shown) to trim and hold the gage diameter of the wellbore. The drill bit 110 also may include gage pads 122, which contact the walls of the wellbore during drilling to maintain the diameter of the wellbore and stabilize the drill bit 110 within the wellbore.

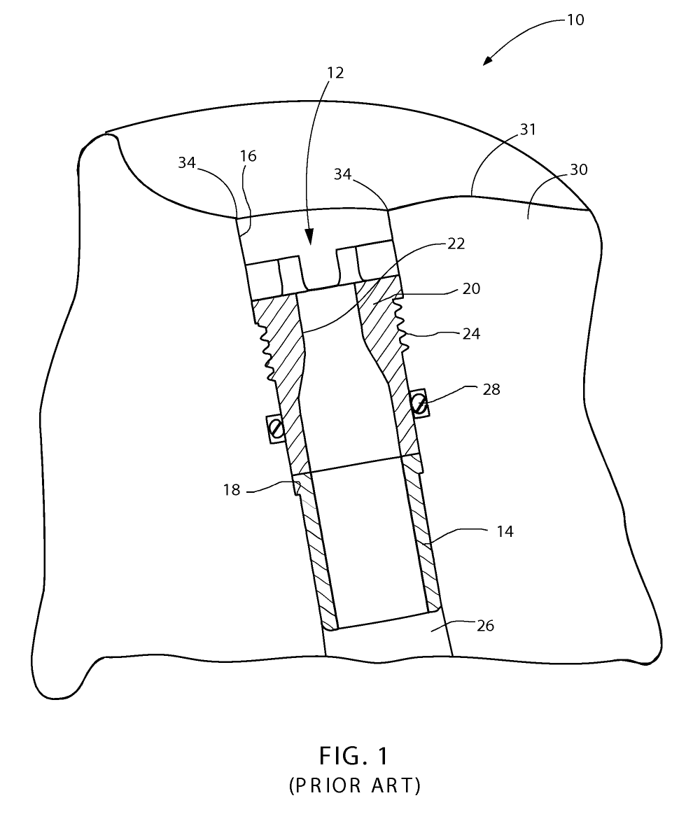

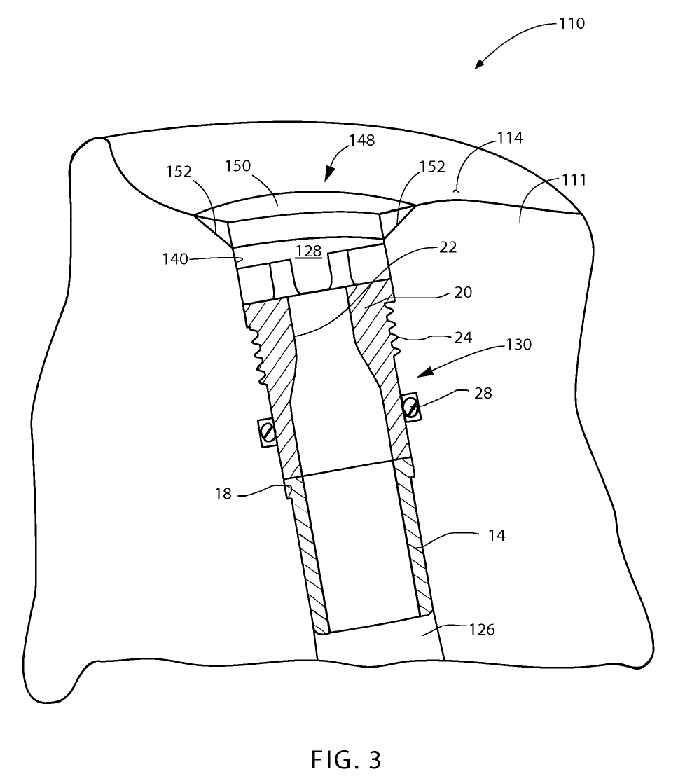

The drill bit 110 also includes a plurality of nozzle assemblies 130, only two of which are visible in FIG. 2. FIG. 3 is an enlarged partial view of a cross-section of a portion of a bit body 111 of the drill bit 110 taken along section line 3-3 shown in FIG. 2. As shown in FIG. 3, each nozzle assembly 130 may be disposed in a nozzle recess 128 formed in the bit body 111 at the end of fluid passageways 126 extending through the bit body 111 to the face 114 of the drill bit 110. As a non-limiting example, the nozzle assemblies 130 may be similar to those previously described in relation to FIG. 1, and may include a tubular tungsten carbide inlet tube 14 that fits into a fluid passageway 126, a nozzle 20 having a restricted bore 22, and an O-ring 28 disposed in an annular groove formed in the surface 140 of the bit body 111 within the nozzle recess 128 to provide a fluid seal between the adjacent surfaces of the bit body 111 and the nozzle 20. As previously discussed, the inlet tube 14 of the nozzle assembly 130 may be seated upon an annular shoulder 18 defined by an inner surface of the bit body 111 where the nozzle recess 128 meets the fluid passageway 126. The nozzle 20 may be secured within the nozzle recess 128 by threads which engage mating threads 24 on the surfaces of the body 111 within the nozzle recess 128. The inlet tube 14 may be retained in the fluid passageway 126 by an abutment between the annular shoulder 18 and the end of the nozzle 20. In additional embodiments of the invention, single piece nozzles may be employed in place of, or in addition to, multi-piece nozzle assemblies like the nozzle assemblies 130 shown in FIGS. 2 and 3. For example, a nozzle 20 may be employed without an inlet tube 14.

During drilling, drilling fluid may be pumped from the surface of the formation being drilled, down through the drill string, into and through fluid passageways 126 within the drill bit 110, and out from the nozzle assemblies 130 to the face 114 of the drill bit 110. The drilling fluid may be used to cool the cutting elements 116 and to flush formation cuttings from the face 114 of the drill bit 110, into the fluid passages 115 and junk slots 117 between the blades 119, and up through the annular space between the drill string and the surfaces of the formation within the wellbore to the surface of the formation. The nozzle assemblies 130 of the drill bit 130 may comprise any type of nozzle known in the art. The nozzle assemblies 130 may be sized and configured for providing different fluid flow volumes, velocities, directions and flow patterns, depending upon the desired drilling hydraulics required at each group of cutting elements 116 to which a particular nozzle assembly 130 directs drilling fluid.

As shown in FIGS. 2 and 3, the drill bit 110 may further include a generally annular-shaped and erosion-resistant structure 148 proximate the area of intersection between the face 114 of the drill bit 110 and the surface 140 of the bit body 111 within the nozzle recesses 128 (or fluid passageways 126). As used herein, the term “annular-shaped” means having a shape similar to a ring. Annular-shaped structures are generally circular, have an aperture that extends through the structure, and have an average diameter that is greater than an average thickness or depth of the structures.

By way of example and not limitation, hardfacing material 150 may be provided between the face 114 of the drill bit 110 and the surface 140. As shown in FIG. 3, a bevel surface 152 may be provided between the face 114 of the drill bit 110 and the surfaces 140, and the hardfacing material 150 may be deposited on the bevel surface 152.

The bevel surface 152 may have a generally frustoconical shape in three-dimensional space, and may extend between the face 114 and the surface 140. In embodiments in which the bit body 111 comprises steel or another machinable metal alloy, such a bevel surface 152 may be formed by machining (e.g., milling or grinding) of the bit body between the face 114 and the surface 140 (e.g., the edge 34 in FIG. 1). In embodiments in which the bit body 111 comprises a particle-matrix composite material (which may be difficult to machine), such a bevel surface 152 may be formed into or otherwise provided on the bit body 111 at the time the bit body 111 is formed. For example, if the bit body 111 is formed in a mold using an infiltration process, a surface or separate displacement may be provided on the mold interior surface having a size and shape configured to form the bevel surface 152 on the bit body 111 as the bit body 111 is formed within the mold.

The hardfacing material 150 may be deposited on the bevel surface 152 using, for example, a manual hardfacing method in which a welding torch (e.g., a flame torch or an arc torch) is used to heat an end of a rod or tube comprising the hardfacing material. As material at the end of the rod or tube melts, the molten material (and solid hard particulate material entrained therein) may be manually deposited on the bevel surface 152. Beads of the hardfacing material 150 may be sequentially deposited on the bevel surface 152 to build up an annular-shaped erosion-resistant mass of the hardfacing material 150 on the bevel surface 152. In additional embodiments, an automated process using a robotic welding device may be used to deposit the hardfacing material 150 on the bevel surface 150. A system that may be used to substantially automatically deposit the hardfacing material 150 on the bevel surface 150 is disclosed in Provisional U.S. Patent Application Ser. No. 61/109,427, which was filed Oct. 29, 2008 and entitled “Method and Apparatus For Robotic Welding of Drill Bits,” the disclosure of which is incorporated herein in its entirety by this reference.

As shown in FIG. 3, the hardfacing material 150 may be deposited on the bevel surface 152 such that the exposed outer surfaces of the hardfacing material are at least substantially flush with the face 114 of the bit body 111 and the surface 140 of the bit body 111 within the nozzle recess 128 (or fluid passageway 126).

The hardfacing material 150 may have a material composition that differs from a material composition of the bit body 111 and is more resistant to erosion relative to the material composition of the bit body 111. Various hardfacing compositions are known in the art and may be used in the present invention. As non-limiting examples, the hardfacing material 150 may comprise a hardfacing composition as disclosed in, for example, U.S. Pat. No. RE37,127 to Schader et al, which reissued Apr. 10, 2001, U.S. Patent Application Publication No. 2007/0056776 A1 (application Ser. No. 11/223,215), which published Mar. 15, 2007, U.S. Patent Application Publication No. 2007/0056777 A1 (application Ser. No. 11/513,677), which published Mar. 15, 2007, and U.S. Patent Application Publication No. 2008/0083568 A1 (application Ser. No. 11/864/482), which published Apr. 10, 2008, the disclosure of each of which is incorporated herein in its entirety by this reference for all purposes. The hardfacing material 150 may be selected to exhibit relatively high resistance to erosion.

Generally, the hardfacing material 150 may include, for example, a particle-matrix composite material comprising a plurality of hard phase regions or particles dispersed throughout a matrix material. The hard ceramic phase regions or particles may comprise, for example, diamond or carbides, nitrides, oxides, and borides (including boron carbide (B₄C)). As more particular examples, the hard ceramic phase regions or particles may comprise, for example, carbides and borides made from elements such as W, Ti, Mo, Nb, V, Hf, Ta, Cr, Zr, Al, and Si. By way of example and not limitation, materials that may be used to form hard phase regions or particles include tungsten carbide (WC), titanium carbide (TiC), tantalum carbide (TaC), titanium diboride (TiB₂), chromium carbides, titanium nitride (TiN), aluminum oxide (Al₂O₃), aluminum nitride (AlN), and silicon carbide (SiC). The metal matrix material of the ceramic-metal composite material may include, for example, cobalt-based, iron-based, nickel-based, iron and nickel-based, cobalt and nickel-based, iron and cobalt-based, aluminum-based, copper-based, magnesium-based, and titanium-based alloys. The matrix material may also be selected from commercially pure elements such as, for example, cobalt, aluminum, copper, magnesium, titanium, iron, and nickel.

The hardfacing material 150 may be deposited on the bevel surface 152 before or after inserting the nozzle assembly 130 into the nozzle recess 128.

Depositing the hardfacing material 150 on the bevel surface 152 before inserting the nozzle assembly 130 may avoid any damage to the bit body 111 and/or nozzle assembly 130 that might arise due to incidental heating of the bit body 111 and the nozzle assembly 130 by the welding torch used to deposit the hardfacing material 150. Such methods, however, must be carried out in such a manner as to ensure that the deposited hardfacing material 150 does not impede subsequent insertion of the nozzle assembly 130 into the nozzle recess 128. Depositing the hardfacing material 150 on the bevel surface 152 after inserting the nozzle assembly 130 may avoid such interference problems, but it may be desirable to limit the heat applied to the bit body 111 and the nozzle assembly 130 when the nozzle assembly 130 is disposed in the nozzle recess 128 to avoid damaging the bit body 111 and/or nozzle assembly 130. If the bit body 111 and the nozzle assembly 130 comprise different materials that exhibit different thermal expansion coefficients, the bit body 111 and/or nozzle assembly 130 may be damaged (e.g., cracked) due to thermal expansion mismatch as the bit body 111 and/or nozzle assembly 130 are heated as the hardfacing material 150 is deposited on the bevel surface 152.

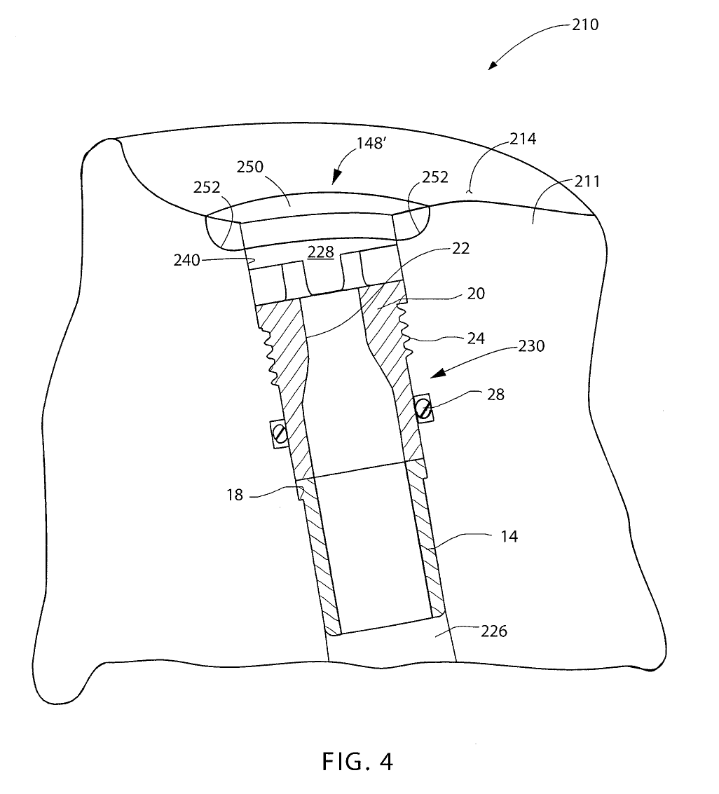

In additional embodiments, the annular-shaped erosion-resistant structure 148 may comprise a separately formed (from the bit body 111) insert that is attached to the bit body 111, similar to the insert 250 shown in FIG. 4 and described in further detail hereinbelow.

FIG. 4 is an enlarged cross-sectional partial view like that of FIG. 3 illustrating another embodiment of drill bit 210 of the present invention. The drill bit 210 may be substantially similar to the previously described drill bit 110 shown in FIGS. 2 and 3 and includes a bit body 211 having a face 214, an internal fluid passageway 226 extending through the bit body 211, and a nozzle recess 228 formed in the bit body 211 at the end of the fluid passageway 226 proximate the face 214 of the bit body 211. A nozzle assembly 230, which may be substantially similar to the previously described nozzle assembly 130 of FIG. 3, may be disposed within the nozzle recess 228 and secured to the bit body 211.

The drill bit 210 of FIG. 4 may further include an annular-shaped erosion-resistant structure 148′ proximate an area of intersection between the face 214 of the drill bit 210 and the surface 240 of the bit body 211 within the nozzle recess 228 (or fluid passageway 226). In the embodiment of FIG. 4, however, a curved or radiused surface 252 may be provided proximate the area of intersection between the face 214 of the drill bit 210 and the surface 240, and an erosion-resistant insert 250 may be attached to the bit body 211 in the recess defined by the radiused surface 252. By way of example and not limitation, an erosion-resistant insert 250 (which may have a composition as previously described herein) may be separately formed from the body 211 and subsequently attached to the body 211.

For example, the erosion-resistant insert 250 may comprise a particle-matrix composite material such as, for example, a cemented tungsten carbide material (e.g., grains of tungsten carbide dispersed throughout a metal matrix material such as cobalt or a cobalt-based alloy). Such an insert may be formed by pressing and sintering a powder mixture comprising hard particles and particles of metal matrix material. Such an insert may be attached to the body 211 (on the radiused surface 252) by, for example, brazing the insert 250 to the body 211 using a metal brazing alloy. In farther embodiments, such an insert 250 may be press-fit or shrink-fit into the nozzle recess 228, although, in such embodiments, it may be desirable to form the insert 250 to comprise a different geometry including a generally cylindrical portion configured to extend at least partially into a complementary generally cylindrical recess formed in the body 211 to ensure that the insert 250 may be securely retained in the body 211. In other embodiments, such as when a bit body is formed using an infiltration process, the erosion-resistant insert 250 may be placed in the mold cavity and secured to the bit body during the infiltration process.

In additional embodiments, a hardfacing material 150 as previously described in relation to FIGS. 2 and 3 may be deposited in the recess defined by the radiused surface 252 of the body 211 of FIG. 4. In other words, either hardfacing material 150 or erosion-resistant inserts 250 may be used in either the embodiment of FIGS. 2 and 3 or the embodiment of FIG. 4.

It is contemplated that surfaces having shapes other than those of the beveled surface 152 and the curved or radiused surface 252 may be provided proximate the area of intersection between the face of a bit body and the surface of the bit body within a nozzle recess or fluid passageway. For example, stepped surfaces may be formed so as to define a generally cylindrical recess in which hardfacing material may be deposited, such that the resulting erosion-resistant structure formed by the hardfacing material has a generally cylindrical shape having exterior surfaces at least substantially flush with the face of the bit body and the surface of the bit body within the nozzle recess or fluid passageway. Further, an annular undercut may be formed in the surface of the bit body within a nozzle recess to provide mechanical as well as metallurgical securement of the hardfacing material.

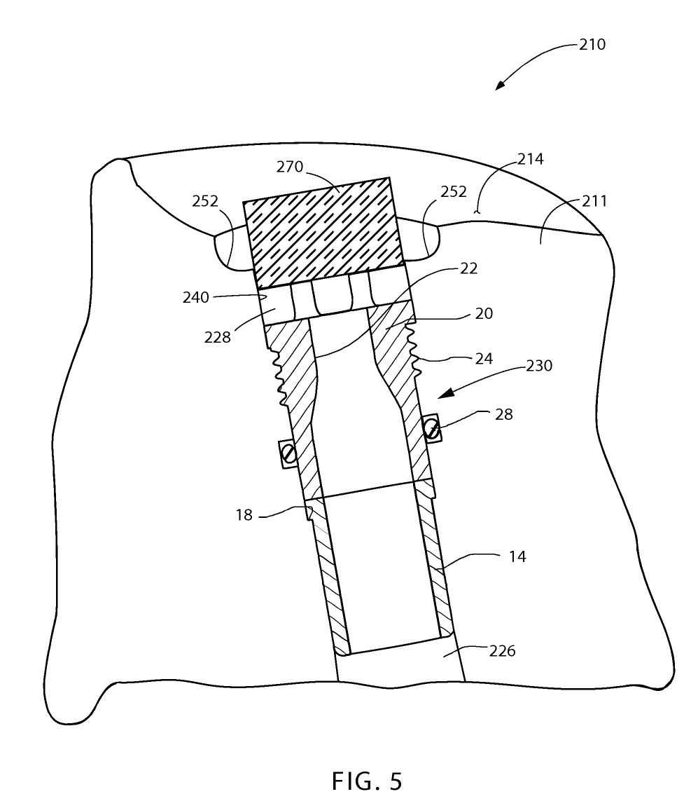

FIG. 5 is an enlarged cross-sectional partial view like that of FIG. 4 illustrating an example embodiment of a method that may be used to form the bit body 211 shown in FIG. 4 (or the bit body 111 shown in FIGS. 2 and 3). As shown in FIG. 5, after providing the curved or radiused surface 252 in the bit body 211, a displacement 270 may be inserted at least partially into the nozzle recess 228. The displacement 270 may be used to ensure that hardfacing material 250 (FIG. 4) to be deposited into the recess defined by the radiused surface 252 remains flush with the surface 240 of the bit body 211 within the nozzle recess 228 and is not accidentally deposited at undesirable locations within the nozzle recess 228.

As shown in FIG. 5, in some embodiments, the displacement 270 may project out from the nozzle recess 228 beyond the face 214 of the bit body 211 when the hardfacing material 250 (FIG. 4) is deposited into the recess defined by the radiused surface 252.

The displacement 270 may comprise, for example, a ceramic material such as aluminum oxide (Al₂O₃), magnesium oxide (Al₂O₃), silicon oxide (SiO₂) or another material that will not degrade or decompose at the temperatures experienced by the displacement 270 when the hardfacing material 250 is deposited, that will not chemically react with the bit body 211 or nozzle assembly 230 in any detrimental way at the temperatures experienced by the displacement 270 when the hardfacing material 250 is deposited, and that will not damage the bit body 211 or the nozzle assembly 230 due to thermal expansion mismatch when the hardfacing material 250 is deposited.

After depositing the hardfacing material 250 in the recess in the bit body 211 defined by the radiused surface 252, the displacement 270 may be removed from the nozzle recess 228. If the displacement 270 is not easily removable from the nozzle recess 228 after depositing hardfacing material 250, the displacement 270 may be fractured into pieces, which then may be removed from the nozzle recess 228, or they may be ground out from the nozzle recess 228 using an abrasive grinding tool.

Although FIG. 5 illustrates the nozzle assembly 230 disposed within the nozzle recess 228 and the displacement 270 disposed in the nozzle recess 228 over the nozzle assembly 230 in preparation for deposition of hardfacing material 250, the displacement 270 may be inserted into the nozzle recess 228 and hardfacing material 250 may be deposited prior to insertion of the nozzle assembly 230 into the nozzle recess 228. In such methods, after depositing the hardfacing material 250, the displacement 270 may be removed from the nozzle recess 228 as previously described, and the nozzle assembly 230 then may be inserted into the nozzle recess 228 and secured to the bit body 211.

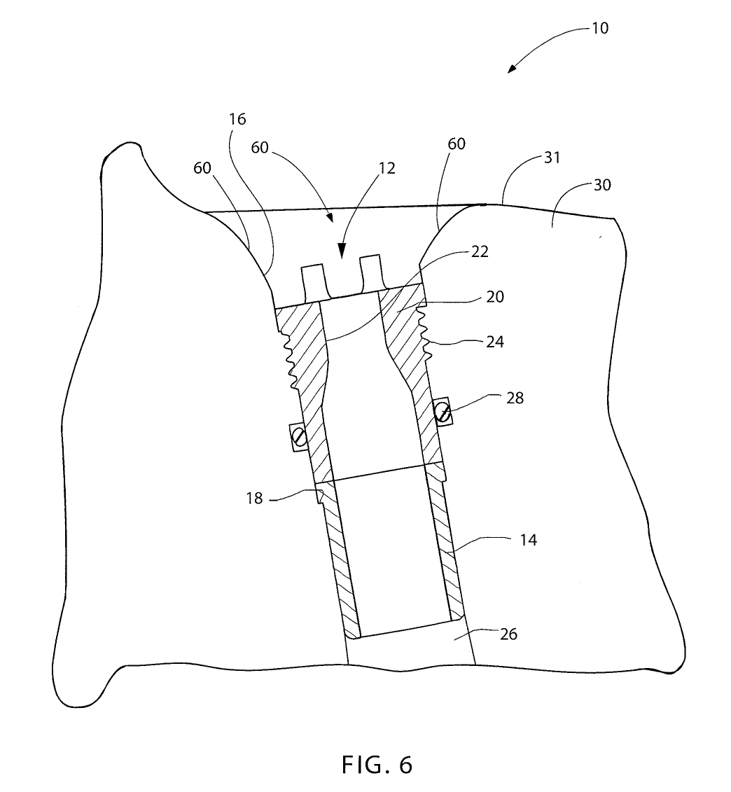

Additional embodiments of the present invention include methods of repairing an earth-boring tool. FIG. 6 illustrates is an enlarged partial cross-sectional view of a portion of the earth-boring tool 10 shown in FIG. 1 and illustrates erosion of the body 30 that may occur due to the flow of drilling fluid out from the nozzle assembly 12 when using the earth-boring tool in forming a wellbore. As shown in FIG. 6, the body 30 has eroded away the previously present edges 34 (FIG. 1) between the face 31 of the body 30 of the tool 10 and the surfaces of the tool body 30 within the nozzle recesses 16 (or fluid passageways 26). As a result, eroded surfaces 60 are formed in the area of intersection between the face 31 of the body 30 of the tool 10 and the surfaces of the tool body 30 within the nozzle recesses 16 (or fluid passageways 26). As previously mentioned, such erosion may detrimentally affect the hydraulic performance of the tool 10 such that the tool 10 is incapable of performing in an efficient manner.

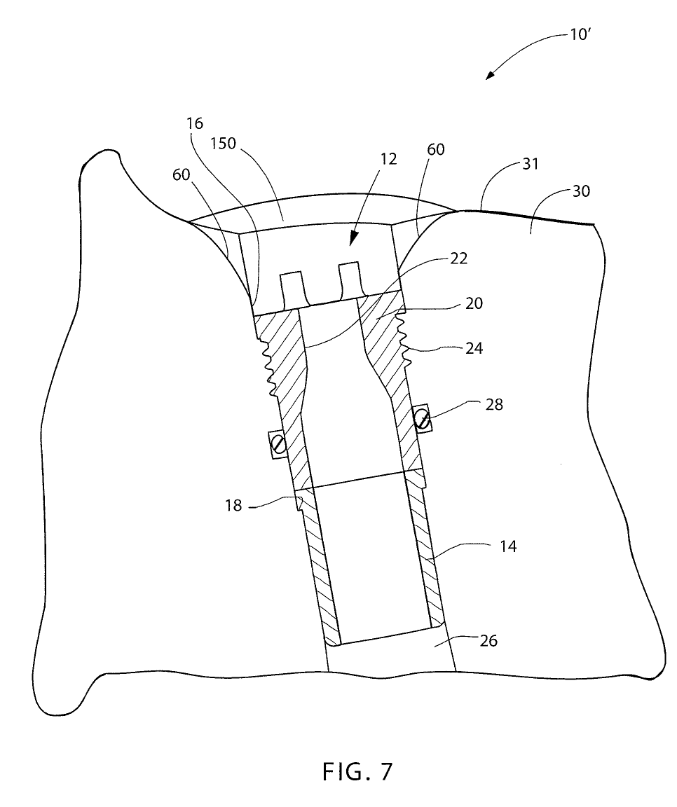

To repair the tool 10, hardfacing material 150 may be deposited on the eroded surfaces 60 of the body 30 (i.e., the surfaces formed by the erosion has occurred) to build the body 30 back up to a shape or configuration substantially similar to its initial shape or configuration (that shown in FIG. 1) to form a repaired tool 10′, as shown in FIG. 7. A displacement 270 may, of course, be used during the repair process, as previously described, to provide a selected aperture size through the applied hardfacing material 150.

Optionally, the eroded surfaces 60 may be machined (e.g., using a milling process, a grinding process, etc.) to a desirable geometry prior to depositing the hardfacing material 150 on body 30. For example, the eroded surfaces 60 may be machined to form a bevel surface 152 (FIG. 3) or a radiused surface 252 (FIG. 4) prior to depositing the hardfacing material 150 on such a bevel surface 152 or radiused surface 252.

In yet further embodiments, the eroded surfaces 60 may be machined to a desirable geometry that is complementary to a separately formed erosion-resistant insert 250 (FIG. 4), as previously described herein, which then may be attached to the body 30 on the machined surfaces. Such an insert 250 may be attached to the body 30 using methods previously described herein, such as, for example, a brazing process.

Although the foregoing description contains many specifics, these are not to be construed as limiting the scope of the present invention, but merely as providing certain example embodiments. Similarly, other embodiments of the invention may be devised which do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

1. An earth-boring tool, comprising:
a body having an outer face and an inner surface defining a fluid passageway; and
an annular-shaped structure disposed proximate an area of intersection between the outer face and the inner surface, the annular-shaped structure comprising a material exhibiting an erosion resistance greater than an erosion resistance exhibited by a material of the body.

2. The earth-boring tool of claim 1, wherein the annular-shaped wear-resistant structure comprises a particle-matrix composite material.

3. The earth-boring tool of claim 2, wherein the particle-matrix composite material comprises a hardfacing material.

4. The earth-boring tool of claim 2, wherein the particle-matrix composite material comprises a cemented tungsten carbide insert.

5. The earth-boring tool of claim 4, further comprising a metal brazing alloy disposed between the cemented tungsten carbide insert and the body.

6. The earth-boring tool of claim 1, wherein the inner surface defines a nozzle recess in the body, and wherein the earth-boring tool further comprises a nozzle disposed within the nozzle recess.

7. The earth-boring tool of claim 1, further comprising a surface extending between the outer face of the body and the inner surface of the body, the surface defining a recess in the body proximate the area of intersection between the outer face of the body and the inner surface of the body, the annular-shaped structure at least partially disposed in the recess.

8. The earth-boring tool of claim 7, wherein the surface defining the recess in the body comprises a bevel surface.

9. The earth-boring tool of claim 7, wherein the surface defining the recess in the body comprises a radiused surface.

10. The earth-boring tool of claim 7, wherein outer exposed surfaces of the annular-shaped structure are at least substantially flush with the outer face of the body and the inner surface of the body.

11. A method of forming an earth-boring tool, the method comprising:
providing an annular-shaped structure proximate an area of intersection between an outer face of a body of the earth-boring tool and an inner surface of the body; and
selecting a material of the annular-shaped structure to comprise a material exhibiting an erosion resistance greater than an erosion resistance exhibited by a material of the body.

12. The method of claim 11, further comprising selecting the material of the annular-shaped structure to comprise a particle-matrix composite material.

13. The method of claim 12, further comprising selecting the material of the annular-shaped structure to comprise a hardfacing material.

14. The method of claim 12, further comprising selecting the material of the annular-shaped structure to comprise a cemented tungsten carbide.

15. The method of claim 11, wherein providing the annular-shaped structure proximate the area of intersection comprises:
forming the annular-shaped structure separate from the body; and
attaching the annular-shaped structure to the body proximate the area of intersection between the outer face of the body of the earth-boring tool and the inner surface of the body.

16. The method of claim 15, wherein attaching the annular-shaped structure to the body comprises brazing the annular-shaped structure to the body.

17. The method of claim 15, wherein attaching the annular-shaped structure to the body comprises providing at least one of a press-fit and a shrink-fit between the annular-shaped structure and the body.

18. The method of claim 11, wherein providing the annular-shaped structure proximate the area of intersection comprises:
forming a surface of the bit body extending between the outer face of the body and the inner surface of the body and defining a recess in the body proximate the area of intersection; and
providing the annular-shaped structure within the recess.

19. The method of claim 18, wherein providing the annular-shaped structure within the recess comprises depositing the material of the annular-shaped structure on the surface of the bit body extending between the outer face of the body and the inner surface of the body, and building up the annular-shaped structure within the recess from the deposited material of the annular-shaped structure.

20. The method of claim 19, wherein depositing the material comprises depositing a hardfacing material.

21. The method of claim 18, further comprising forming the surface of the bit body extending between the outer face of the body and the inner surface of the body to comprise a bevel surface.

22. The method of claim 18, further comprising forming the surface of the bit body extending between the outer face of the body and the inner surface of the body to comprise a radiused surface.

23. The method of claim 18, further comprising forming the annular-shaped structure to comprise outer exposed surfaces at least substantially flush with the outer face of the body and the inner surface of the body.

24. The method of claim 11, further comprising securing a nozzle to the body within a nozzle recess in the body at least partially defined by the inner surface of the body.

25. An earth-boring rotary drill bit, comprising:
a bit body comprising:
an outer face;
an inner surface defining a nozzle recess in the bit body; and
a surface extending between the outer face of the bit body and the inner surface of the bit body, the surface defining a recess in the bit body between the outer face and the inner surface; and
hardfacing material disposed within the recess, the hardfacing exhibiting an erosion resistance greater than an erosion resistance exhibited by a material of the bit body.

26. The earth-boring rotary drill bit of claim 25, wherein outer exposed surfaces of the hardfacing material are at least substantially flush with the outer face and the inner surface of the bit body.

27. The earth-boring rotary drill bit of claim 26, wherein the material of the bit body comprises a metal alloy.

28. The earth-boring rotary drill bit of claim 27, wherein the material of the bit body comprises steel.

29. The earth-boring rotary drill bit of claim 28, wherein the hardfacing material comprises a particle-matrix composite material including hard particles dispersed throughout a metal matrix phase.

30. The earth-boring rotary drill bit of claim 29, wherein the hard particles comprise tungsten carbide and the metal matrix phase comprises a nickel-based alloy.

31. A method of repairing an earth-boring tool, the method comprising:
providing an annular-shaped structure over an eroded surface of a body of a previously used earth-boring tool between an outer face of the body and an inner surface of the body; and
selecting a material of the annular-shaped structure to comprise a material exhibiting an erosion resistance greater than an erosion resistance exhibited by a material of the body.

32. The method of claim 31, wherein providing an annular-shaped structure over the eroded surface of the body comprises depositing a hardfacing material on the eroded surface of the body.

33. The method of claim 31, wherein providing an annular-shaped structure over the eroded surface of the body comprises:
machining the eroded surface of the body to form a machined surface of the body; and
depositing a hardfacing material on the machined surface of the body.

34. The method of claim 33, wherein providing an annular-shaped structure over the eroded surface of the body comprises:
machining the eroded surface of the body to form a machined surface of the body;
forming an erosion-resistant insert separate from the body; and
attaching the erosion-resistant insert to the machined surface of the body.

35. The method of claim 34, wherein attaching the erosion-resistant insert to the machined surface of the body comprises brazing the erosion-resistant insert to the machined surface of the body.
